(19) United States
(12) Patent Application Publication
(10) Pub. No.: US 2026/0264341 A1
(43) Pub. Date: Sep. 10, 2026

(54) TOOL FOR BONDING AN ANTI-WEAR STRIP TO A TURBOMACHINE VANE

(71) Applicant: SAFRAN AIRCRAFT ENGINES, Paris (FR)

(72) Inventors: Damien Bruno LAMOUCHE, MOISSY-CRAMAYEL (FR); Steven Gerard Joseph BIENVENU, MOISSY-CRAMAYEL (FR); Matthieu Patrick Jean Roger PERLIN, MOISSY-CRAMAYEL (FR)

(21) Appl. No.: 19/582,799

(22) PCT Filed: Oct. 24, 2024
(86) PCT No.: PCT/FR2024/051396

§ 371 Date: Apr. 28, 2026

(30) Foreign Application Priority Data
Oct. 30, 2023 (FR) FR2311826

(51) Int. Cl. B29C 65/22; B23Q 3/06; B29C 65/00; F01D 5/28

(52) U.S. Cl. CPC B29C 65/224; B23Q 3/063; B29C 66/81455; F01D 5/288; F05D 2230/23

(57) ABSTRACT

A tool for bonding at least one anti-wear strip to a turbomachine blade comprising: —a support, —at least one first fastening member which is fastened to the support and is able to cooperate with the root of the blade in order to immobilize it with respect to the support and —at least one second member for holding said at least one anti-wear strip on the blade and for heating this anti-wear strip for the bonding thereof, this second member being fastened to the support and comprising, on the one hand, at least one expandable bag, and, on the other hand, at least one heating element able to heat said at least one anti-wear strip for the bonding thereof.

### TECHNICAL FIELD OF THE INVENTION

This invention relates to a tool for bonding at least one anti-wear strip to a turbomachine vane. It also relates to an assembly comprising a tool and a vane, as well as a bonding method using the tool.

### TECHNICAL BACKGROUND

The technical background comprises the documents US-A-3,305,420, US-A1-2018/009068, JP-A-H 08 192484 and FR-A 1-3 108 940.

The use of composite materials is particularly advantageous in the aeronautical industry because these materials are relatively light and have good mechanical properties.

A composite material conventionally used in aeronautics comprises a fibrous preform embedded in a polymer resin. The preform may be woven in three dimensions or obtained by draping and superimposing several fabrics.

The resin may be injected into the preform or the preform may be pre-impregnated with the resin.

The final part is generally shaped using a tool comprising a mold. If a resin is to be injected into a preform, the preform is placed in the cavity of a mold and the mold is covered with a counter-mold. The tool comprises an injection port for injecting resin into the cavity of the mold and a vacuum port for evacuating the cavity of the mold.

If the preform is already impregnated with resin, the preform is placed in the cavity of a mold, which may be covered with a flexible tarpaulin or a counter-mold.

The tool also comprises an injection port for injecting resin into the cavity of the mold and a vacuum port for evacuating the cavity of the mold. The counter-mold applies a pressure to the preform by evacuating the preform between the counter-mold and the flexible tarpaulin or the mold. The use of a counter-mold gives greater control over the thickness of the final part.

In the case of a vane, in particular for a fan, after the molding operation described above, an operation to apply anti-wear strips to the root and the stilt of the vane must be carried out.

These strips are currently fitted and secured to the root and the stilt of the vane by bonding. The anti-wear strips are first impregnated with adhesive, usually phenolic, by hand. The operator then places the anti-wear strips on the root and the stilt of the vane, still by hand.

The vane coated with the anti-wear strips is then replaced in the mold and the anti-wear strips are vacuum-bonded using a counter-mold or a silicone tarpaulin. The assembly is then autoclaved to heat the strips and bond them to the vane. The adhesive used to attach the strips is of the heat-curing type and requires a heating cycle to perform its function.

This operation of bonding the anti-wear strips is therefore very manual and generates numerous defects in the final part. One of the difficulties encountered with the current method for bonding anti-wear strips to a vane is the difficulty of positioning the strips, to within several tens of millimeters, by hand on a left-hand form and the difficulty of maintaining this positioning of the strips during the operation of installing the vane coated with anti-wear strips in the mold and during the vacuum bonding operation.

In addition, there is a significant risk of leakage from the tarpaulin during the autoclave heating cycle (incorrect application of gaskets, presence of thermocouples, micro-perforation of the watertight tarpaulin, etc.), which may lead to non-compliance. Moreover, this heating cycle generates a lot of waste, as the tarpaulins are single-use consumables (several tones a year).

The overall cost of the current method is also relatively high.

Finally, the composite material of the vane may be relatively sensitive to high temperatures and may be thermally affected by the autoclave heating operation. This may have an impact on the number of times the vane may be reworked/repaired, and may limit the time the vane may be used in service.

The present invention offers a solution to at least some of the problems discussed below.

### SUMMARY OF THE INVENTION

The invention relates to a tool for bonding at least one anti-wear strip to a vane of turbomachine, this vane comprising a root connected to a blade and at least one anti-wear strip located on the vane, the tool comprising:
a support,
at least one first attachment member which is attached to the support and which is able to cooperate with the vane in order to immobilize it with respect to the support, characterized in that it further comprises:
at least one second member for holding said at least one anti-wear strip on the vane and for heating this anti-wear strip for the bonding thereof, this second member being attached to the support and comprising on the one hand at least one expandable bag capable of adopting a first unexpanded position and a second expanded position wherein said at least one bag is capable of applying a pressure to at least one anti-wear strip located on the vane, and on the other hand at least one heating element capable of heating said at least one anti-wear strip for the bonding thereof.

The invention provides several advantages. Firstly, it allows the anti-wear strip or strips to be precisely positioned and held on the vane by the second holding member or members to prevent them moving during bonding. In addition, this member or members may apply a predetermined pressure to the strip or strips, this pressure being a function of the expansion of the bag or bags. Each bag may be expanded between two positions. Finally, the heating member or members allow the strip or strips to be heated locally, which avoids having to autoclave the entire vane and therefore heat the entire vane. Only the area of the vane receiving the anti-wear strip or strips may be heated, for example by conduction through the strip, which limits the exposure of the vane material to the heating cycle and therefore improves its service life. Lastly, the tool is relatively simple and less bulky, and much less expensive than a mold configured to completely enclose the vane with a view to bonding anti-wear strip or strips.

The tool according to the invention may comprise one or more of the following characteristics, taken alone or in combination with each other:
said at least one second member is independent of said at least one first attachment member;
said at least one expandable bag is or comprises at least one inflatable bladder;
said at least one second member comprises at least one channel for supplying pressurized air to said at least one inflatable bladder;
said at least one heating element is or comprises at least one heating mat, and in particular a resistive heating mat;
said at least one heating mat is located on or under said at least one expandable bag;
said second member comprises a first bag able to extend on a first side of the vane or of its root, a second bag able to extend on a second opposite side of the vane or its root, or even a third bag able to extend on an upstream or downstream edge of the vane or of its root;
said second member defines an elongate slot which is configured to receive the vane or its root by sliding and which comprises one or more bags along its inner edges.

The present invention also relates to an assembly comprising a tool as described above and a vane of turbomachine, this vane comprising a root connected to a blade and at least one anti-wear strip located on the vane.

The assembly according to the invention may comprise one or more of the following characteristics, taken alone from each other, or in combination with each other:
the or each anti-wear strip is made by weaving fibers such as aramid fibers and/or PTFE;
the vane is made of a composite material from a fibrous preform, the fibers of which, for example carbon, are coated or impregnated with polymerizable and in particular cross-linkable resin (such as an epoxy resin).

The present invention also relates to a method for bonding at least one anti-wear strip to a vane of turbomachine, this vane comprising a root connected to a blade and at least one anti-wear strip located on the vane, the method using a tool as described above and comprising the following steps:
a. immobilizing the vane with respect to the support of the tool, by means of the first attachment member,
b. expanding said at least one bag and applying a pressure to said at least one anti-wear strip located on the vane, and
c. heating this anti-wear strip for the bonding thereof to the vane, by means of said at least one heating element.

Advantageously, prior to step a), the root of the vane is inserted into the slot of the second member.

Preferably, before step a) and mounting the vane in the tool, the or each anti-wear strip is coated with adhesive and positioned on the vane.

The adhesive is a phenolic adhesive, for example.

### BRIEF DESCRIPTION OF THE FIGURES

Further characteristics and advantages will be apparent from the following description of a non-limiting embodiment of the invention with reference to the appended drawings wherein:

FIG. 1 is a schematic perspective view of a vane for an aircraft turbomachine,

FIG. 2 is a schematic view on a larger scale of a portion of the vane in FIG. 1, and in particular of its root on which anti-wear strips are located,

FIG. 3 is a very schematic cross-sectional view of a tool for bonding anti-wear strips to the vane,

FIG. 4 is a schematic perspective view of a portion of the tool shown in FIG. 3,

FIG. 5 is a schematic perspective view of a tool for bonding anti-wear strips to a vane, in accordance with one embodiment of the invention,

FIG. 6 is another schematic perspective view of the tool shown in FIG. 5,

FIG. 7 is a schematic perspective view of a detail of the tool shown in FIG. 5,

FIG. 8 is a schematic view of a further detail of the tool in FIG. 5, and

FIG. 9 is another schematic perspective view of the tool shown in FIG. 5.

### DETAILED DESCRIPTION OF THE INVENTION

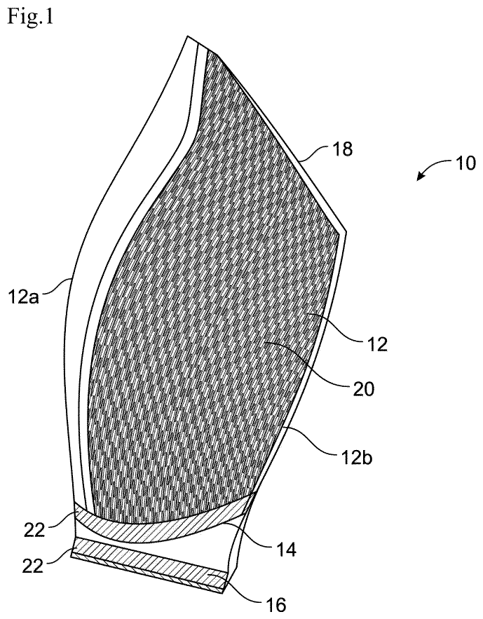

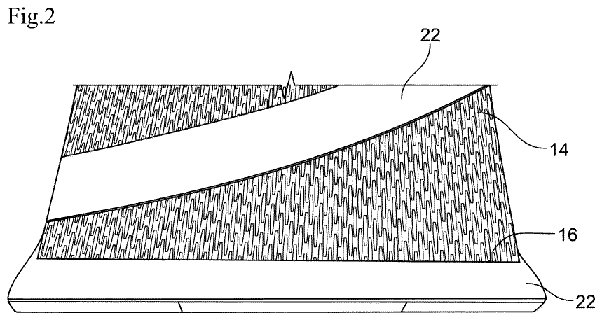

Reference is first made to FIGS. 1 and 2, which illustrate a composite material vane 10 for a turbomachine, in particular for an aircraft, this vane 10 being, for example, a propeller or fan vane.

The vane 10 comprises a blade 12 connected, for example, by a stilt 14 to a root 16. The root 16 may be dovetail-shaped and is configured to engage in a complementary-shaped groove in a rotor disk, in order to hold the vane on this disk.

The blade 12 comprises a leading edge 12a and a trailing edge 12b of the gases flowing through the turbomachine. The blade 12 has a curved or twisted aerodynamic profile and comprises a pressure side 18 and a suction side 20 extending between the leading 12a and trailing 12b edges.

Anti-wear fabric strips 22 are secured to the vane 10.

In the example shown, the vane 10 comprises four anti-wear strips 22, namely two on each side of the root 16 and two others on each side of the stilt 14 or of the blade 12.

As their name suggests, the strips 22 are configured to limit wear on the walls to which they are secured, by contact and/or friction. These strips 22 are located on the root 16 and the stilt 14 or the blade 12 which are likely to come into contact with bearing surfaces of the aforementioned rotor disk.

Each strip 22 has a generally elongated shape and extends substantially from the leading edge 12a to the trailing edge 12b of the blade 12. For example, a strip 22 has a length of between 2 and 50 cm, and a width of between 2 and 7 cm.

An anti-wear strip 22 is made by weaving fibers such as aramid fibers and/or PTFE.

The vane 10 is made of a composite material from a fibrous preform, the fibers of which, for example carbon, are coated or impregnated with a polymerizable and in particular cross-linkable resin (such as an epoxy resin).

The tool used to manufacture the vane 10 comprises a mold and a counter-mold, the mold and the counter-mold defining between them a cavity configured to receive the fibrous preform.

When manufacturing a vane, the tool is opened and a fibrous preform is placed in the cavity. This arrangement may be made with a three-dimensional woven preform or with fabrics that are draped and superimposed in the cavity. This step may be carried out manually or using a robot. The tool is then closed by attaching in a sealing manner the counter-mold to the mold.

The preform is pre-impregnated with resin or resin is injected into the mold to impregnate the preform.

The tool is heated to raise the temperature of the resin and cause it to polymerize.

Once the resin has polymerized and the vane has stiffened, the strips 22 are bonded to the vane 10, using a phenolic adhesive for example.

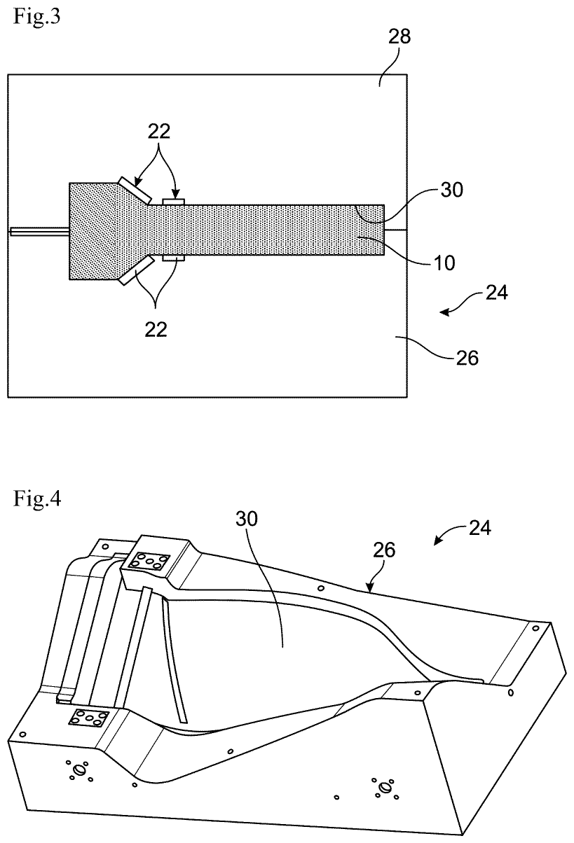

For this purpose, the tool 24 shown in FIGS. 3 and 4 is used in the prior art.

The tool 24 comprises a mold 26 and a counter-mold 28 or a flexible tarpaulin, the mold 26 and the counter-mold 28 defining between them a cavity 30 configured to receive the vane 10 (FIG. 3).

Before installing the vane 10 in the mold, the strips 22 of fabric are coated with the adhesive and then the strips are positioned on the vane 10. The vane 10 is then installed between the mold 26 and the counter-mold 28. The strips 22 are held on the vane 10 and applied with a certain pressure to the vane 10 by compressing the vane 10 between the mold 26 and the counter-mold 28 or by evacuating the tarpaulin covering the vane 10 and the mold 26.

The tool 24 is then autoclaved so as to heat the adhesive and ensure polymerization. The strips 22 are then secured to the vane 10, which may be removed from the mold after the autoclave heating cycle.

Alternatively, the strips 22 may be bonded to the out-of-mold vane 10.

The bonding operation therefore remains essentially a manual operation, which is a source of numerous defects in the final part, as we saw earlier.

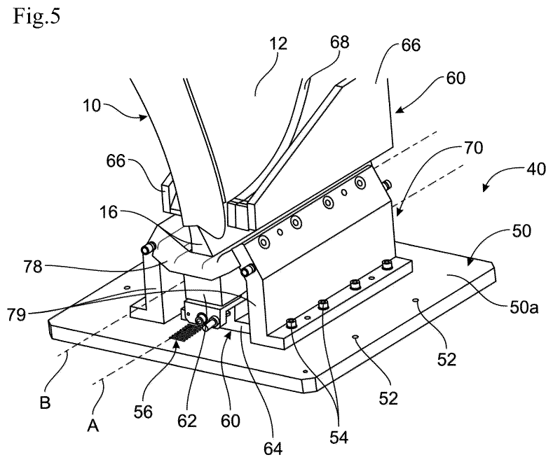

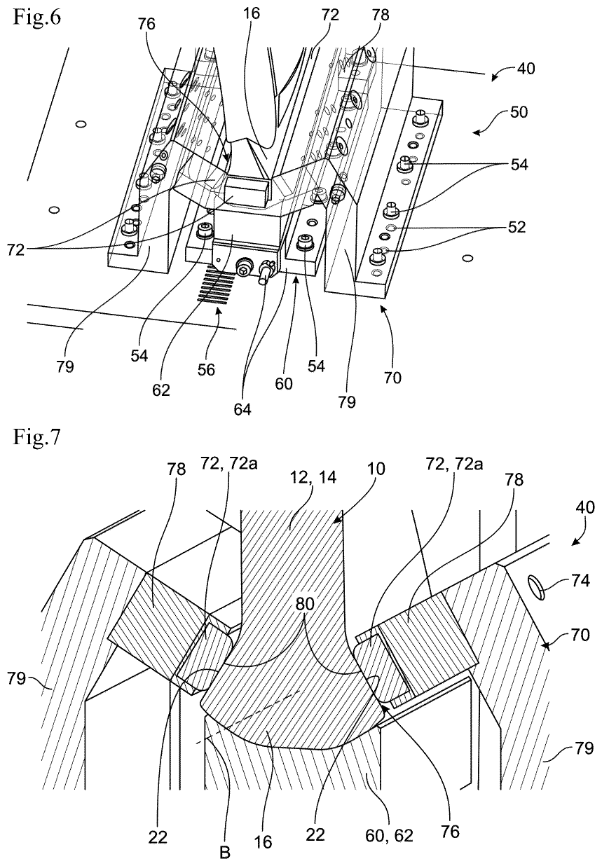

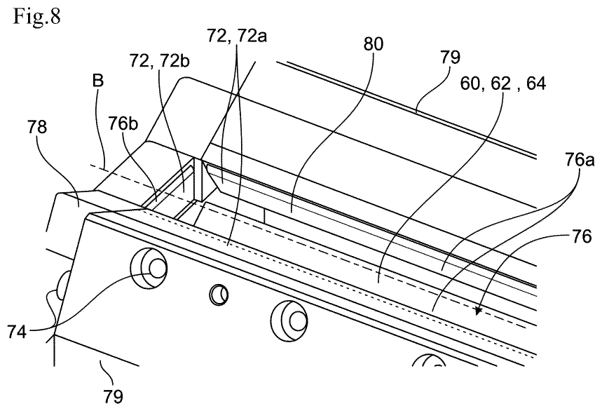

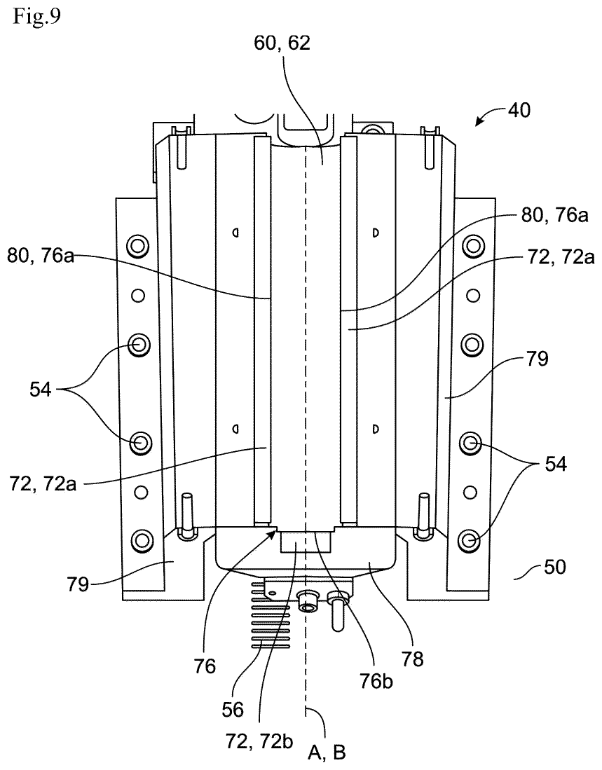

FIG. 5 and following illustrate an embodiment of a tool 40 according to the invention, which allows one or more strips 22 to be bonded to a vane 10.

This tool 40 essentially comprises three portions, namely:
a support 50,
at least one attachment member 60 for attaching the vane 10,
at least one member 70 for holding the strip or strips 22 to the vane 10.

In the example shown, the support 50 is in the form of a flat plate configured to be laid flat on a horizontal surface such as a workshop workbench.

The support 50 thus comprises a substantially flat and horizontal upper surface 50a in the example.

The support 50 may comprise a plurality of threaded holes 52 for screwing in screws 54.

The support 50 may comprise markings 56, such as positioning lines, configured to facilitate the positioning of the vane 10 when it is mounted in the tool 40.

The attachment member 60, also known as the first member, is attached to the support 50 and is able to cooperate with the vane 10, and for example or in particular its root 16, in order to immobilize it with respect to the support 50.

In the example shown, the attachment member 60 firstly comprises a base 62 which is attached to the support 50 and which is configured to be interposed between the vane 10 and the support 50. In other words, the vane 10 rests on the base 62 attached to the support 50.

The position of the base 62 may be adjusted relative to the support 50, in particular along an axis A which is configured to extend along an axis B along which the root 16 extends. The position of the base 62 along the axis A may thus be modified and immobilized, the aforementioned marks 56 providing a reference for the position chosen or to be adopted.

By moving the base 62 on the support, the vane 10 may be precisely positioned relative to the support 50.

The displacement of the base 62 on the support 50 may be made possible by a system 64 of the slide rail type carried by the support 50 and configured to receive the base 62.

The attachment of the system 64 on the support 50 or the immobilization of the base 62 on the support 50 may be made by means of the aforementioned screws 54.

In the example shown, the attachment member 60 also comprises jaws 66 which are configured to extend on either side of the vane 10 or its root 16 and which are configured to clamp it in order to immobilize it.

It is understood that the distance between the jaws 66 is adjustable, for example from a spread position allowing the vane 10 to be mounted between the jaws 66, to a close position allowing the vane 10 to be clamped and immobilized between the jaws 66.

Flexible pads 68, for example made of elastomer, may be carried by the jaws 66 and rests on the vane 10 to avoid damaging its material.

Although not shown in the drawings, these jaws 66 may be connected or attached to the support 50 by appropriate means.

The holding member 70, also known as the second member, has a dual function.

It is used to hold the strip or strips 22 to the vane 10 and also to heat each of its strips 22 for bonding. Autoclaving the tool 10 is therefore no longer necessary.

The holding member 70 is attached to the support 50 by means of the aforementioned screws 54, for example.

As may be seen from the drawings, and in particular FIG. 5, the members 60 and 70 are advantageously independent. This means that they are attached to the support 50 independently of each other and may also be dismantled independently of each other. This also means that they may be operated and adjusted independently of each other.

The holding member 70 comprises on the one hand at least one expandable bag 72 capable of adopting a first unexpanded position and a second expanded position in order to apply a predetermined pressure to the or each strip 22 located on the vane, and on the other hand at least one heating element 80 capable of heating the or each strip 22 for the bonding thereof.

Expansion means the capacity to increase volume. The or each bag 72 therefore has the capacity to increase in volume and to move from an unexpanded position of low volume to an expanded position of greater volume.

In a preferred embodiment, the or each bag 72 is or comprises at least one inflatable bladder. The bladder is inflated using a fluid, such as air. It is therefore understood that supplying air to the bladder causes it to inflate and therefore expand, and that evacuating the air contained in the bladder causes it to deflate and therefore reduce in volume.

In the case where each bag 72 is an inflatable bladder, the member 70 comprises at least one channel 74 for supplying pressurized air to each bladder as shown in FIG. 7.

A bladder may be inflated in a few seconds (between 2 and 10 seconds for example), at a relative pressure of between 0.1 bar and 3 bar for example (0.01 to 0.3 MPa), this relatively low level of pressure allowing the use of inexpensive and readily available tools.

In the example shown, the tool 40 comprises several bags 72 or bladders. There are three of these bags 72, for example, although this number is not limitative.

The member 70 defines an elongate slot 76 which is configured to receive the vane 10 or its root 16 by sliding and which comprises one or more bags along its inner edges.

The member 70 is generally M-shaped in the example shown and comprises a central portion 78 comprising this slot 76. The sides of the member 70 and the M shape are formed by two tabs 79 which are attached to the support by screws 54.

The central portion 78 of the member 70 extends above the base 62. It is therefore understood that the root 16 of the vane 10 is inserted into the slot 76 and rests on the base 62 located directly under the slot 76.

The slot 76 is open at one of its longitudinal ends, opposite the markings 56. The slot 76 thus comprises three edges, namely two lateral edges 76a configured to extend on either side of the vane 10 or its root 16, and a central edge 76b connecting these lateral edges 76a.

As may be seen in the drawings, each of these edges 76a, 76b carries a bag 72. The bags 72a located at the level of the edges 76a are elongated and extend along the entire length of the slot 72. These bags 72 are configured, in the expanded position, to rest on the strips 22 applied to the vane 10, in order to apply a certain pressure to these strips.

The bag 72b located at the level of the edge 76b extends across the entire width of the slot 72. It rests on the vane 10 and in particular on an upstream (or leading) or downstream (or trailing) edge of the vane or its root, but is not necessarily used to rest on a strip 22 of the vane.

The or each heating element 80 may be or may comprise at least one heating mat, and in particular a resistive heating mat. This heating mat may be located on or under each bag 72. It may therefore be in direct contact with the strip to be heated or heat a strip through the bag 72, by conduction and/or convection. Heating by conduction allows more local heating and less risk of thermally affecting the material of the vane 10.

Alternatively, the or each heating element 80 is formed by an electrical heating resistor integrated, for example, into the or each bag 72.

The heating element 80 is preferably capable of heating the strip 22 to a temperature of between 80° C. and 200° C., for example.

This invention also relates to the assembly formed by the tool 40 and the vane 10.

The present invention also relates to a method for bonding at least one anti-wear strip to a turbomachine vane 10, this method using the tool 40 as described above.

The method comprises the following steps, some of which are optional:
the strips are coated with adhesive and positioned on the vane 10 or its root 16,
the bags 72 of the tool are (brought) into an unexpanded position,
the vane is mounted in the tool 40, by inserting its root between the jaws 66, i.e. in the slot 72 of the member 70,
the vane 10 is immobilized relative to the support 50 by the attachment member 60,
the bags 72 are expanded so that they adopt their expanded position and rest on the strips 22 located on the vane 10, and apply a certain pressure to these strips 22,
the heating of the strips 22 is activated with a view to bonding them to the vane, by means of the heating element 80 of each bag 72; the heating may be carried out at a polymerization temperature of between 80° C. and 200° C. for a period of between 1 hour and 4 hours, depending on the adhesive used.

It is understood that the position of the bags 72 of the member 70 depends on the position of the strips 22 on the vane 10. In the example shown, the strips are located at the level of the root 16 of the vane 10 and the bags 72 are therefore located at the level of the root of the vane. Alternatively, the strips may be located at the level of another area of the vane, so the bags 72 would be located at the level of this area. The tool 40 would therefore be adapted according to the position of the strips 22 on the vane 10 and this adaptation would be within the reach of the person skilled in the art.

The invention thus offers a number of advantages, including:
reducing the exposure of the vane to the adhesive's heating and curing cycle (which reduces the impact on the number of times the vane needs to be reworked/repaired),
reliable positioning and holding of the vane during the bonding and polymerization step,
maintaining the pressure of the strips on the vane,
reducing the time and cost of implementing the bonding, in particular by simplifying tool,
eliminating the risk of non-compliance linked to a leakage from the vacuum tarpaulin of the prior art,
reducing waste from the autoclave bonding method,
using the tool for manufacturing the vane, and also for any repairs required to replace the anti-wear strips.

1. A tool for bonding at least one anti-wear strip to a vane of turbomachine, this vane comprising a root connected to a blade and at least one anti-wear strip located on the vane, the tool comprising:
a support
at least one first attachment member which is attached to the support and which is able to cooperate with the vane in order to immobilize it with respect to the support characterized in that it further comprises:
at least one second member for holding said at least one anti-wear strip on the vane and for heating this anti-wear strip for the bonding thereof, this second member being attached to the support and comprising on the one hand at least one expandable bag capable of adopting a first unexpanded position and a second expanded position wherein said at least one bag is capable of applying a pressure to at least one anti-wear strip located on the vane, and on the other hand at least one heating element capable of heating said at least one anti-wear strip for the bonding thereof.

2. The tool according to claim 1, wherein said at least one second member is independent of said at least one first attachment member.

3. The tool (40) according to claim 1, wherein said at least one expandable bag (72) is or comprises at least one inflatable bladder.

4. The tool according to claim 3, wherein said at least one second member comprises at least one channel for supplying pressurized air to said at least one inflatable bladder.

5. The tool according to claim 1, wherein said at least one heating element is or comprises at least one heating mat, and in particular a resistive heating mat.

6. The tool according to claim 5, wherein said at least one heating mat is located on or under said at least one expandable bag

7. The tool according to claim 1, wherein said second member comprises a first bag able to extend on a first side of the vane or of its root a second bag able to extend on a second opposite side of the vane or of its root, or even a third bag able to extend on an upstream or downstream edge of the vane or of its root.

8. The tool according to claim 1, wherein said second member defines an elongate slot which is configured to receive the vane or its root by sliding and which comprises one or more bags along its inner edges.

9. An assembly comprising a tool and a vane of turbomachine, this vane comprising a root connected to a blade and at least one anti-wear strip located on the vane, the tool comprising:
a support,
at least one first attachment member which is attached to the support and which is able to cooperate with the vane in order to immobilize it with respect to the support, characterized in that it further comprises:
at least one second member for holding said at least one anti-wear strip on the vane and for heating this anti-wear strip for the bonding thereof, this second member being attached to the support and comprising on the one hand at least one expandable bag capable of adopting a first unexpanded position and a second expanded position wherein said at least one bag is capable of applying a pressure to at least one anti-wear strip located on the vane, and on the other hand at least one heating element capable of heating said at least one anti-wear strip for the bonding thereof.

10. The assembly according to claim 9, wherein the or each anti-wear strip is made by weaving fibers such as aramid fibers and/or PTFE.

11. The assembly according to claim 9, wherein the vane is made of a composite material from a fibrous preform, the fibers of which, for example carbon, are coated or impregnated with polymerizable resin and in particular cross-linkable resin.

12. A method for bonding at least one anti-wear strip to a vane of turbomachine, this vane comprising a root connected to a blade and at least one anti-wear strip situated on the vane, the method using a tool comprising:
a support,
at least one first attachment member which is attached to the support and which is able to cooperate with the vane in order to immobilize it with respect to the support, characterized in that it further comprises:
at least one second member for holding said at least one anti-wear strip on the vane and for heating this anti-wear strip for the bonding thereof, this second member being attached to the support and comprising on the one hand at least one expandable bag capable of adopting a first unexpanded position and a second expanded position wherein said at least one bag is capable of applying a pressure to at least one anti-wear strip located on the vane, and on the other hand at least one heating element capable of heating said at least one anti-wear strip for the bonding thereof,
wherein the method comprises the following steps:
a) immobilizing the vane with respect to the support of the tool by means of the first attachment member
b) expanding said at least one bag and applying a pressure to said at least one anti-wear strip located on the vane, and
c) heating this anti-wear strip for the bonding thereof to the vane, by means of said at least one heating element.

13. The method according to claim 12, wherein the tool is as defined in claim 8 and wherein, prior to step a), the root of the vane is inserted into the slot of the second member.
